(19) United States
(12) Patent Application Publication
(10) Pub. No.: US 2012/0244366 A1
(43) Pub. Date: Sep. 27, 2012

(54) MEDICAL DEVICE AND METHOD FOR PRODUCTION THEREOF

(75) Inventors: Yosuke Kuruma, Kanagawa (JP); Takao Anzai, Shizuoka (JP)

(73) Assignee: TERUMO KABUSHIKI KAISHA, Shibuya-ku (JP)

(21) Appl. No.: 13/492,319

(22) Filed: Jun. 8, 2012

Related U.S. Application Data
(63) Continuation of application No. PCT/JP2010/072267, filed on Dec. 10, 2010.

(30) Foreign Application Priority Data
Dec. 15, 2009 (JP) 2009-284478

(51) Int. Cl. B32B 15/08; C25D 5/00

(52) U.S. Cl. 428/461; 205/147

(57) ABSTRACT

A medical device on which a water-swellable polymeric material is strongly bonded to the surface of the substrate such as an electrically conductive material. A medical device that includes an electrically conductive material and a water-swellable polymeric material having reactive functional groups and being previously crosslinked, the reactive functional groups of the water-swellable polymeric material being chemically bonded with ions existing on the surface of the electrically conductive material.

### CROSS REFERENCE TO RELATED APPLICATIONS

This application is a continuation of International Application No. PCT/JP2010/072267 filed on Dec. 10, 2010, which claims priority to Japanese Application No. 2009-284478 filed on Dec. 15, 2009, the entire content of both of which is incorporated herein by reference.

### TECHNICAL FIELD

Disclosed is a medical device and a method for production thereof. For example, disclosed is a medical device having a coating film of a water-swellable polymeric material formed on the surface of an electrically conductive material, where the water-swellable polymeric material adheres directly and strongly to the surface of the electrically conductive material through chemical bonding. Also disclosed is a method for producing the medical device by simple processes and also in a manner that the thickness of the coating film of the water-swellable polymeric material can be easily controlled.

### BACKGROUND DISCUSSION

Medical devices, such as catheters and guide wires, to be inserted and indwelled in the living body can be required to have good lubricity so that they are less liable to damage tissues (such as blood vessels) and easy to manipulate for the operator. This has been practically achieved by coating the substrate surface with a hydrophilic polymer having lubricity. Regarding such medical devices, it poses problems if the hydrophilic polymer for imparting lubricity is eluted and peeled off from the coated substrate surface in terms of safety and handling.

In order to tackle the foregoing problem, there has been proposed a medical device in U.S. Application Publication No. 2009/0124984 A1, in which its metallic surface is coated directly with a hydrophilic organic compound having polar groups without any intermediate layer by way of electrochemical reaction. The advantage of this medical device is that the hydrophilic coating film can be made thin because the hydrophilic organic compound directly adheres to the metal surface without any intermediate layer. Another advantage is that the individual molecules of the hydrophilic organic compound adhere to the metal surface through electrochemical reaction, which prevents the hydrophilic coating film from peeling off or falling while the medical device is being used.

The present inventors' investigation into the disclosure of U.S. Application Publication No. 2009/0124984 A1 revealed that there remain problems as follows. According to the disclosure, the bonding of the hydrophilic organic compound to the metal surface is achieved through polar groups attached to both ends of the molecule of the hydrophilic organic compound. In the case of bonding in this way, there are as many bonding points as polar groups possessed by the hydrophilic organic compound. In other words, one molecule of the hydrophilic organic compound produces two bonding points, which are not enough for the hydrophilic organic compound to firmly bond to the metal surface. Consequently, there will be limitation in the strength of bonding between the hydrophilic coating film and the metal surface. This raises the possibility of the hydrophilic coating film peeling off or falling from the metal (substrate) surface under certain conditions of use.

The method disclosed in U.S. Application Publication No. 2009/0124984 A1 may be useful in the case where the metal surface of the medical device is to be coated with a thin film of a hydrophilic organic compound. However, it is not adequate in the case where the coating film is desired to have a certain thickness, because the portion of the hydrophilic coating film away from the metal surface would not bond directly to the metal surface. The result is that the hydrophilic coating film may be eluted and peeled off from the substrate surface if it is to be formed thick. U.S. Application Publication No. 2009/0124984 A1 describes that the thickness of the coating film can be controlled by adjusting the molecular weight of the hydrophilic organic compound. In fact, however, it is difficult to obtain a sufficient film thickness only by the adjustment of the molecular weight. In the case of the medical device disclosed in the above-mentioned patent document, the coating film of the hydrophilic organic compound is a thin monomolecular layer. Such a thin coating film disclosed by U.S. Application Publication No. 2009/0124984 A1 cannot provide sufficient lubricity and drug retaining ability, nor does it function as the scaffold for cells when it is applied to a medical device such as a stent which is to be indwelled in the living body.

Controlling the thickness of the hydrophilic coating film by changing the amount of the hydrophilic organic compound to be applied is difficult because the thickness varies depending on the kind (structure) and crosslinking conditions of the compound used.

### SUMMARY

One aspect of the disclosure here involves a medical device having a coating film of a water-swellable polymeric material which is firmly bonded to the surface of the substrate (for example, an electrically conductive material) without the possibility of peeling off or falling therefrom.

According to another aspect disclosed by way of example, a medical device has a coating film of which thickness is easily controlled. The present inventors conducted extensive studies, which led to the finding that a substrate (for example, an electrically conductive material) can be firmly bonded with a film of certain thickness which is formed from a water-swellable polymeric material having a plurality (for example, three or more) of reactive functional groups and being previously crosslinked. It was also found that the thus obtained coating film permits easy thickness control because its thickness can be equal to the size (which varies depending on the degree of crosslinking) of each molecule of the water-swellable polymeric material which is previously crosslinked and has a three-dimensional expanse.

A medical device is disclosed in which ions existing on the surface of an electrically conductive material are chemically bonded to the reactive functional groups of a previously crosslinked water-swellable polymeric material.

The medical device can have a coating film of a water-swellable polymeric material firmly bonded onto the surface of the substrate (for example, an electrically conductive material) even when the coating film has a certain thickness. The thickness of the coating film of water-swellable polymeric material can be easily controlled.

The medical device can comprise an electrically conductive material and a water-swellable polymeric material having reactive functional groups and being previously crosslinked, the reactive functional groups of the water-swellable polymeric material being chemically bonded with ions existing on the surface of the electrically conductive material.

According to another aspect disclosed by way of an example, a method for producing a medical device, said method comprising: immersing an electrically conductive material and an electrode in a solution of a water-swellable polymeric material having reactive functional groups and being previously crosslinked; and applying a voltage across the electrically conductive material and the electrode with one of the two functioning as an anode and the other as a cathode, to bring about chemical reaction between ions existing on the surface of the electrically conductive material and the reactive functional groups.

### BRIEF DESCRIPTION OF THE DRAWINGS

FIG. 1 is a schematic diagram illustrating the structure of the medical device pertaining to an exemplary embodiment. The reference numerals 1 to 6 in FIG. 1 denote the medical device 1, electrically conductive material (substrate) 2, coating film 3, water-swellable polymeric material 4, chemical linkage 5, and crosslinked structure 6, respectively.

FIG. 2 is a diagram illustrating a method for producing the medical device according to another exemplary embodiment. The reference numerals 10 to 15 in FIG. 2 denote the electrochemical reacting apparatus 10, electrolytic bath 11, anode 12, cathode 13, water-swellable polymeric material 14, and aqueous solution 15, respectively.

### DETAILED DESCRIPTION

Provided is a medical device that includes an electrically conductive material and a water-swellable polymeric material having reactive functional groups and being previously crosslinked (for example, hereinafter referred to as “water-swellable polymeric material”), in which the reactive functional groups of the water-swellable polymeric material are chemically bonded with ions existing on the surface of the electrically conductive material. For example, the medical device has an electrically conductive material as the substrate and thereon a coating film of previously crosslinked water-swellable polymeric material, for example, having a plurality (for example, three or more) of reactive functional groups. The coating film is bonded to the surface of the electrically conductive material through chemical linkage between the reactive functional groups of the water-swellable polymeric material and ions existing on the surface of the electrically conductive material. The term “previously crosslinked” refers to the water-swellable polymeric material being crosslinked before, for example, the water-swellable polymeric material is bonded to the surface of the electrically conductive material.

The following is a detailed description of an embodiment disclosed as an example.

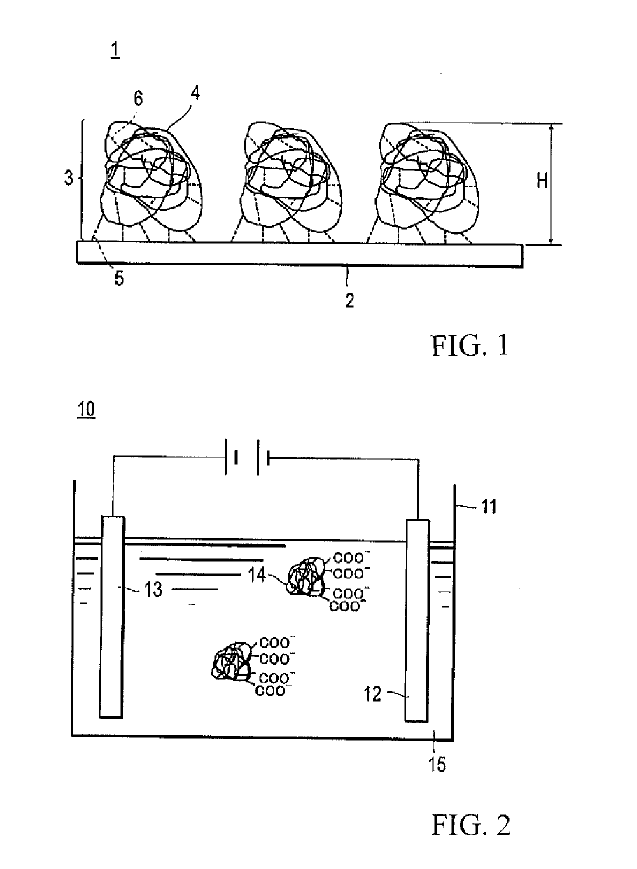

FIG. 1 is a schematic diagram illustrating the structure of the medical device pertaining to an exemplary embodiment. This diagram is exaggerated for the sake of clarity. The technical scope of exemplary aspects is not restricted to the illustrated one but can be variously changed and modified.

The medical device 1 shown in FIG. 1 is composed of an electrically conductive material (or substrate) 2 and the coating film 3 of the water-swellable polymeric material 4 which is formed on the electrically conductive material 2. There is chemical linkage 5 between the reactive functional groups of the water-swellable polymeric material 4 and those ions existing on the surface of the electrically conductive material 2.

In the exemplary medical device, the surface of the electrically conductive material (substrate) 2 thereof is coated with the coating film 3 of the previously crosslinked water-swellable polymeric material 4 which has a plurality (for example, three or more) of reactive functional groups. An exemplary advantage of this structure is that the water-swellable polymeric material 4 forms the chemical linkage 5 directly with those ions existing on the surface of the electrically conductive material 2, so that the coating film 3 firmly adheres to the electrically conductive material (substrate) 2. In addition, the water-swellable polymeric material 4 has a large number of reactive functional groups that form the chemical linkage 5 with those ions existing on the surface of the electrically conductive material 2, so that there occurs chemical linkage (covalent linkage) at many points on the surface of the electrically conductive material which serves as the substrate. For this reason, the coating film of the water-swellable polymeric material firmly adheres to the electrically conductive material. Therefore, the coating film would not peel off or fall even when the medical device, indwelled in the living body, rubs against tissues. This leads to the excellent durability of the exemplary medical device.

The water-swellable polymeric material 4 has the previously crosslinked structure 6. In other words, it has a three-dimensional structure as shown in FIG. 1. The height (indicated by “H” in FIG. 1) of the water-swellable polymeric material 4 adhering to the electrically conductive material 2 through chemical linkage is equal to the thickness of the coating film 3. This thickness can be easily controlled by defining the size (degree of crosslinking and molecular weight, etc.) of the water-swellable polymeric material 4. A coating film with a large thickness can be formed by increasing the size of the water-swellable polymeric material 4. Such coating film permits the medical device to exhibit good lubricity and drug retaining ability and to function as the scaffold for cells when it is applied to medical devices designed to be indwelled in the living body, for example a stent.

According to an exemplary aspect, the water-swellable polymeric material 4 has the previously crosslinked structure 6, and the previously crosslinked water-swellable polymeric material 4 is bonded onto the electrically conductive material 2 through chemical linkage. By contrast, there is comparative technology in which the coating film is once formed and crosslinking (or post-crosslinking) is performed thereafter so as to strengthen the film. Post-crosslinking causes the coating film to shrink, which leads to strain, cracking, peeling off and falling. The exemplary medical device is free of or highly unlikely to have such troubles because it is coated with the previously crosslinked polymeric material.

In addition to the above, an exemplary medical device 1 has exemplary advantages as follows. The coating film 3 of the water-swellable polymeric material 4 adheres directly to the electrically conductive material (substrate) 2 through chemical linkage without any intermediate layer interposed between them. This eliminates the necessity of considering the peeling off or falling of the intermediate layer from the electrically conductive material (substrate) 2 and the coating film 3. In addition, the absence of the intermediate layer eliminates the necessity of considering the effect of the constituents of the intermediate layer because, even when the coating film 3 does not completely coat the electrically conductive material (substrate) 2, partially leaving an exposed part (or uncoated part), the exposed part is the electrically conductive material (substrate).

The following is a detailed description of the constitution of the medical device pertaining to an exemplary embodiment. The exemplary embodiment mentioned below is not intended to restrict the technical scope.

### Electrically Conductive Material

The medical device is constructed of an electrically conductive material which has on the surface thereof ions capable of chemical linkage with the reactive functional groups of the water-swellable polymeric material. The electrically conductive material is not specifically restricted in its type so long as it possesses ions capable of chemical linkage with the reactive functional groups of the water-swellable polymeric material as mentioned above. It may be properly selected according to the type of the medical device to which it is applied. Thus, the electrically conductive material may be either a polymer or metal. The electrically conductive polymer is not specifically restricted; any of the known ones for medical devices is acceptable. Examples include a resin containing electrically conductive filler, and one obtained by applying metal plating film or metal deposited film to such resin. The metal is not specifically restricted; any of the known ones for medical devices is acceptable. Examples include nickel-titanium alloy (Ni—Ti alloy), cobalt-chromium alloy (Co—Cr alloy), stainless steel (such as SUS304, SUS316L, SUS420J2, and SUS630), iron, titanium, aluminum, tin, zinc-tungsten alloy, gold, silver, copper, platinum, and alloys thereof. The electrically conductive material can be a metal, for example, nickel-titanium alloy or stainless steel (such as SUS316L).

The electrically conductive material is used as the substrate, and it is not specifically restricted in shape. Its shape depends on the medical device to which it is applied.

### Water-Swellable Polymeric Material

The medical device contains as a constituent the water-swellable polymeric material which is previously crosslinked (or has the crosslinked structure) and has a plurality (for example, three or more) of reactive functional groups capable of chemical linkage with those ions existing on the surface of the electrically conductive material. Here, the chemical linkage implies any chemical linkage that occurs between the reactive functional groups of the water-swellable polymeric material and those ions existing on the surface of the electrically conductive material. For example, it may be electrochemical linkage, chemical reaction-induced linkage, and so forth. For example, the linkage is a chemical linkage caused by electrochemical reactions between the reactive functional groups and those ions existing on the surface of the electrically conductive material. The chemical linkage of this type permits the water-swellable polymeric material to firmly bond with (adhere to) the surface of the electrically conductive material, thereby suppressing or preventing its peeling off or falling from the substrate.

The water-swellable polymeric material may have any structure so long as it is previously crosslinked (or it has a crosslinked structure). Moreover, it can have a plurality (for example, three or more) of reactive functional groups. The number of the reactive functional groups is not specifically restricted in its upper limit. The water-swellable polymeric material has a three-dimensionally expanding structure because it is previously crosslinked as mentioned above. The water-swellable polymeric material is not specifically restricted in shape; it may have a spherical, substantially spherical shape or elliptic shape. It may also be in a crushed or irregular form, or in a shape of a column such as cuboid, plate, pyramid, cone, straight shape such as fiber, branched shape, and so on. A spherical or substantially spherical shape is exemplary. One in the form of fine particles is suitable. The water-swellable polymeric material is not specifically restricted in size; however, it is exemplary to have a size which is substantially equal to the thickness of the coating film to be formed on the electrically conductive material. Such size facilitates the control of the thickness of the coating film. When the water-swellable polymeric material is in the form of fine particles, they can have an average particle diameter of 0.1 to 20 μm, for example, 1 to 10 μm, in the dry state. This particle size is adequate for the water-swellable polymeric material to form a monomolecular layer adhering to the electrically conductive material. The resulting layer will have a desirable thickness and very firm adherence with the electrically conductive material such that peeling off or falling of the coating film would hardly occur or would not occur at all. The coating film with such a thickness exhibits sufficient lubricity and drug retaining ability and functions as the scaffold for cells when it is applied to a medical device to be indwelled in the living body. Further, the coating film mentioned above has a smooth surface free of irregularities and a uniform thickness when it is bonded to the electrically conductive material. Therefore, for example, even when the medical device is a stent, the coating film permits the endothelial cells to grow at a substantially uniform rate, and variation of its adhesion to blood platelets can be avoided. The above-mentioned particle size leads to small gaps between fine particles and hence contributes to strong adhesion between the fine particles. In addition, particles of such size are easy to produce. The “average particle diameter in the dry state” of the fine particles of the water-swellable polymeric material is a value measured using a Coulter counter.

The reactive functional groups of the water-swellable polymeric material are not specifically restricted so long as they are capable of chemical bonding with those ions existing on the surface of the electrically conductive material. They are, for example, polar functional groups. Examples of the reactive functional groups include carboxyl group (—COOH), amino group (—NH₂), imino group (═NH, —NH—), amide group (—CONH₂), imide group (—CONHCO—), epoxy group, isocyanate group (—NCO), cyano group (—CN), nitro group (—NO₂), mercapto group (—SH), and phosphino group (—PH₂). Exemplary among these examples are carboxyl group and amide group. A water-swellable polymeric material having these functional groups swell under certain pH conditions and gives rise to a coating film that is highly hydrophilic and exhibits good antithrombosis.

The water-swellable polymeric material is not specifically restricted in structure. It can be one that is obtained by crosslinking a (co)polymer composed of monomers having the above-mentioned reactive functional groups by a crosslinking agent.

Examples of the monomer (as a constituent of the water-swellable polymeric material) having carboxyl groups unrestrictedly include (meth)acrylic acid, maleic acid, fumaric acid, glutaconic acid, itaconic acid, crotonic acid, sorbic acid, and cinnamic acid. The foregoing monomers may be in the form of salt, such as sodium salt, potassium salt, and ammonium salt. The monomer in the form of salt yields a water-swellable polymeric material by (co)polymerization which is capable of acid treatment mentioned later. Exemplary among the foregoing monomers are (meth)acrylic acid and sodium (meth)acrylate which yield a polymer capable of swelling from the neutral to alkaline region (pH 7 and up). The term “(meth)acrylic acid” denotes both acrylic acid and methacrylic acid.

Examples of the monomer (as a constituent of the water-swellable polymeric material) having amino groups unrestrictedly include (meth) allylamine, aminoethyl (meth)acrylate, aminopropyl (meth)acrylate, dimethylaminoethyl (meth)acrylate, diethylaminoethyl (meth)acrylate, methyl ethylaminoethyl (meth)acrylate, dimethylaminopropyl (meth)acrylate, dimethylaminostyrene, diethylaminostyrene, and morpholino ethyl (meth) acrylate.

Examples of the monomer (as a constituent of the water-swellable polymeric material) having imino groups unrestrictedly include N-methylaminoethyl (meth)acrylate, N-ethylaminoethyl (meth)acrylate, and N-t-butylamino-ethyl (meth)acrylate.

Examples of the monomer (as a constituent of the water-swellable polymeric material) having amide groups unrestrictedly include (meth) acrylamide, N-methyl (meth) acrylamide, N-ethyl (meth) acrylamide, N-n-propyl (meth) acrylamide, N-isopropyl (meth) acrylamide, N-n-butyl (meth) acrylamide, N-isobutyl (meth) acrylamide, N-s-butyl (meth) acrylamide, N-t-butyl (meth) acrylamide, N,N-dimethyl (meth) acrylamide, N-ethyl-N-methyl (meth) acrylamide, N,N-diethyl (meth) acrylamide, N-methyl-N-isopropyl (meth) acrylamide, N-methyl-N-n-propyl (meth) acrylamide, N-ethyl-N-isopropyl (meth) acrylamide, N-ethyl-N-n-propyl (meth) acrylamide, N,N-di-n-propyl (meth) acrylamide, diacetone (meth) acrylamide, crotonic amide, and cinnamic amide. Exemplary among these examples are (meth) acrylamides because of their high safety in the living body and past good performance in the field of orthopedics. The term “(meth) acrylamide” denotes both acrylamide and methacrylamide.

Examples of the monomer (as a constituent of the water-swellable polymeric material) having imide groups unrestrictedly include N-(4-vinylphenyl)maleimide.

Examples of the monomer (as a constituent of the water-swellable polymeric material) having epoxy groups unrestrictedly include glycidyl (meth)acrylate and (meth) allyl glycidyl ether.

Examples of the monomer (as a constituent of the water-swellable polymeric material) having isocyanate groups unrestrictedly include 2-(meth) acryloyloxyethyl isocyanate, 3-(meth) acryloyloxypropyl isocyanate, 4-(meth) acryloyloxybutyl isocyanate, 6-(meth) acryloyloxyhexyl isocyanate, 8-(meth)acryloyloxyoctyl isocyanate, 10-(meth) acryloyloxydecyl isocyanate, and 2-(2-isocyanateethoxy)ethyl (meth)acrylate.

Examples of the monomer (as a constituent of the water-swellable polymeric material) having cyano groups unrestrictedly include (meth)acrylonitrile, crotononitrile, cyanomethyl (meth)acrylate, 1-cyanoethyl (meth)acrylate, 2-cyanoethyl (meth)acrylate, 1-cyanopropyl (meth)acrylate, 2-cyanopropyl (meth)acrylate, 3-cyanopropyl (meth)acrylate, 4-cyanobutyl (meth)acrylate, 6-cyanohexyl (meth)acrylate, 2-ethyl-6-cyanohexyl (meth) acrylate, and 8-cyanooctyl (meth)acrylate.

Examples of the monomer (as a constituent of the water-swellable polymeric material) having nitro groups unrestrictedly include 4-nitrostyrene. Examples of the monomer (as a constituent of the water-swellable polymeric material) having mercapto groups unrestrictedly include vinylmercaptan and allylmercaptan.

Examples of the monomer (as a constituent of the water-swellable polymeric material) having phosphino groups unrestrictedly include 4-diphenylphosphinostyrene, 4-dibenzylphosphinostyrene, diethylphosphinostyrene, and 2-(diphenylphosphino) ethyl (meth)acrylate.

The above-mentioned monomers may be used alone or in combination with one another. In the foregoing examples, it is assumed that each monomer has one reactive functional group. However, each monomer may have two or more reactive functional groups.

Exemplary among the foregoing examples of monomers are those which have carboxyl groups and amide groups. The water-swellable polymeric material composed of these monomers swells under specific pH conditions and provides a coating film having a highly hydrophilic and antithrombotic surface.

An adequate selection can be made from the reactive functional groups of the water-swellable polymeric material according to the charge of ions existing on the surface of the electrically conductive material. For example, in the case where the electrically conductive material is used as the anode as shown in FIG. 2, it can be desirable to select a water-swellable polymeric material which contains a specific amount of monomers having reactive functional groups (such as carboxyl groups) to be negatively charged in an (aqueous) solution. There are no specific restrictions on the amount of the monomer having the reactive functional groups capable of chemical linkage with those ions existing on the surface of the electrically conductive material. An adequate amount can be selected according to the strength of bonding with the electrically conductive material, the type and number of the reactive functional groups existing in the water-swellable polymeric material, and the size of the water-swellable polymeric material. The content of the monomers having functional reactive groups capable of chemical linkage with those ions existing on the surface of the electrically conductive material can be 10 to 50 mol %, for example, 20 to 40 mol %, for the total amount of monomers constituting the water-swellable polymeric material. This content is sufficient for the water-swellable polymeric material to have as many reactive functional groups as necessary for chemical linkage at a plurality of points with the surface of the electrically conductive material as the substrate. As a result, the coating film of the water-swellable polymeric material is firmly bonded (adhered) to the electrically conductive material. Consequently, the medical device keeps the coating film thereon without peeling off or falling even when it receives loads after indwelling in the living body.

The water-swellable polymeric material has a crosslinked structure. The water-swellable polymeric material can be formed by crosslinking of a copolymer having constituent units derived from (meth) acrylamide monomers and constituent units derived from unsaturated carboxylic acids, such as (meth)acrylic acid, by a crosslinking agent.

No specific restrictions are imposed on the foregoing crosslinking agent to be used for the water-swellable polymeric material. It includes (i) one having two or more polymerizable unsaturated groups, (ii) one having one each of a polymerizable unsaturated group and a reactive functional group other than a polymerizable unsaturated group, or (iii) one having two or more reactive functional groups other than a polymerizable unsaturated group. These crosslinking agents may be used alone or in combination with one another.

The crosslinking agent may be used, or the water-swellable polymeric material may be produced in any way without specific restrictions so long as the above-mentioned structure is obtained. One of the following processes may be employed.

A process in which a monomer having reactive functional groups is (co)polymerized in the presence of the crosslinking agent and optionally post-crosslinking is performed thereafter.

A process in which a monomer having reactive functional groups is first (co)polymerized and then crosslinking is performed on the resulting (co)polymer with the crosslinking agent.

A process in which specific monomers are (co)polymerized and the resulting (co)polymers are reacted with a compound having specific reactive functional groups to thereby give the reactive functional groups to the (co)polymers, and then crosslinking is performed on the resulting product with the crosslinking agent.

A process in which specific monomers are (co)polymerized and crosslinking is performed on the resulting polymers with the crosslinking agent, and then the crosslinked (co)polymers are reacted with a compound having specific reactive functional groups so as to give the reactive functional groups to the crosslinked (co)polymers.

The first two processes mentioned above are exemplary. In the case of copolymerization with monomers having carboxyl groups and monomers having amide groups, it can be desirable to use the aforementioned crosslinking agents (i), (ii), and (iii) in the following way.

In the case where the foregoing crosslinking agent (i) is used alone, copolymerization with monomers having amide groups and monomers having carboxyl groups (or salt thereof) is performed in such a way that the crosslinking agent (i) is added to the polymerization system at the time the copolymerization is performed.

In the case where the foregoing crosslinking agent (iii) is used alone, copolymerization with monomers having amide groups and monomers having carboxyl groups (or salt thereof) is performed and crosslinking by, for example, heating in the presence of the crosslinking agent (iii) is performed thereafter.

In the case where the foregoing crosslinking agent (ii) is used alone, or in the case where two or three of the foregoing crosslinking agents (i), (ii), and (iii) are used in combination, copolymerization with monomers having amide groups and monomers having carboxyl groups (or salt thereof) is performed in the presence of the crosslinking agent in the polymerization system, and also post-crosslinking by heating can be performed thereafter.

Examples of the foregoing crosslinking agent (i), which has two or more polymerizable unsaturated groups, include N,N′-methylenebisacrylamide, N,N′-methylenebismethacrylamide, N,N′-ethylenebisacrylamide, N,N′-ethylenebismethacrylamide, N,N′-hexamethylenebisacrylamide, N,N′-hexamethylenebismethacrylamide, N,N′-benzylidenebisacrylamide, N,N′-bis(acrylamidemethylene)urea, ethylenglycol di(meth)acrylate, polyethyleneglycol di(meth)acrylate, propyleneglycol di(meth)acrylate, glycerin (di- or tri)acrylate, trimethylolpropane triacrylate, triallylamine, triallyl cyanurate, triallyl isocyanurate, tetraallyloxy ethane, pentaerythritol triallyl ether, (poly)ethyleneglycol di(meth)acrylate, (poly)propyleneglycol di(meth)acrylate, trimethylolpropane tri(meth)acrylate, glycerin tri(meth)acrylate, glycerin acrylate methacrylate, ethyleneoxide-modified trimethylolpropane tri(meth)acrylate, pentaerythritol hexa(meth)acrylate, triallyl phosphate, poly(meth)allyloxyalkane, (poly)ethyleneglycol diglycidyl ether, glycerol diglycidyl ether, ethylene glycol, polyethylene glycol, propylene glycol, glycerin, pentaerythritol, ethylenediamine, ethylene carbonate, propylene carbonate, and glycidyl (meth)acrylate.

Examples of the foregoing crosslinking agent (ii), which has one each of a polymerizable unsaturated group and a reactive functional group other than a polymerizable unsaturated group, include hydroxyethyl (meth)acrylate, N-methylol (meth) acrylamide, and glycidyl (meth)acrylate.

Examples of the foregoing crosslinking agent (iii), which has two or more reactive functional groups other than polymerizable unsaturated groups, include polyhydric alcohol (such as ethylene glycol, diethylene glycol, glycerin, propylene glycol, and trimethylolpropane), alkanolamine (such as diethanolamine), and polyamine (such as polyethyleneimine).

Exemplary among the foregoing examples is the crosslinking agent (i) having two or more polymerizable unsaturated groups, for example, N,N′-methylenebisacrylamide.

The crosslinking agent may be used in any amount without specific restrictions. An adequate amount is 0.05 to 0.5 pbw, for example, 0.1 to 0.3 pbw, for 100 pbw of the total amount of the monomers. This amount is sufficient for the crosslinking reaction to proceed completely and controlling the size of the resulting polymer within an adequate range.

The (co)polymerization mentioned above may be accomplished in any way without specific restrictions. Any process that employs a polymerization initiator may be available, such as solution polymerization, emulsion polymerization, suspension polymerization, reverse-phase suspension polymerization, thin-film polymerization, and spray polymerization. The control of polymerization may be achieved by means of adiabatic polymerization, temperature-controlled polymerization, and isothermal polymerization. Polymerization may be initiated not only by use of a polymerization initiator but also by radiation, electron rays, or UV light. It can be desirable to use reverse-phase suspension polymerization with a polymerization initiator.

In the case of reverse-phase suspension polymerization, the solvent for the continuous phase can be an aliphatic organic solvent (such as n-hexane, n-heptane, n-octane, n-decane, cyclohexane, methylcyclohexane, and liquid paraffin), aromatic organic solvent (such as toluene and xylene), or halogenated organic solvent (such as 1,2-dichloroethane). Exemplary among these solvents are aliphatic organic solvents, such as hexane, cyclohexane, and liquid paraffin. They may be used alone or in combination with one another.

A dispersion stabilizer may be added to the above-mentioned continuous phase. With its type and amount properly selected, the resulting water-swellable polymeric material will have a controlled and desirable size (e.g., particle size).

Examples of the foregoing dispersion stabilizer include nonionic surfactants, such as polyoxyethylene lauryl ether, polyoxyethylene oleyl ether, polyoxyethylene stearyl ether, sorbitan sesquioleate, sorbitan trioleate, sorbitan monolaurate, sorbitan monooleate, sorbitan monopalmitate, sorbitan monostearate, sorbitan tristearate, glycerol monostearate, glycerol monooleate, glyceryl stearate, glyceryl caprate, sorbitan stearate, sorbitan oleate, and coconut fatty acid sorbitan.

The foregoing dispersion stabilizer can be used in an amount of 0.04 to 20 wt %, for example, 1 to 15 wt %, for the total amount of the solvent for the continuous phase. This amount is suitable for polymerization free of coagulation and gives a uniform particle size distribution.

The monomer concentration used for the reverse-phase suspension polymerization is not specifically restricted in concentration within an exemplary range. An adequate concentration is 2 to 7 wt %, for example, 2.5 to 5 wt %, for the total amount of all materials (i.e., the total amount of the continuous phase and monomer solution).

The polymerization initiator to be used for the reverse-phase suspension polymerization mentioned above may be selected from those exemplified below.

Persulfates (such as potassium persulfate, ammonium persulfate, and sodium persulfate), peroxides (such as methyl ethyl ketone peroxide, methyl isobutyl ketone peroxide, di-t-butyl peroxide, t-butyl cumyl peroxide, t-butyl peroxyacetate, t-butyl peroxyisobutyrate, t-butyl peroxypivalate, and hydrogen peroxide), and azo compounds (such as 2,2′-azobis[2-(N-phenylamizino)propane]dihydrochloride, 2,2′-azobis[2-(N-allylamizio)propane]dihydrochloride, 2,2′-azobis{2-[1-(2-hydroxyethyl)-2-imidazolin-2-yl]propane}dihydrochloride, 2,2′-azobis{2-methyl-N-[1,1-bis(hydroxymethyl)-2-hydroxyethyl]propionamide}, 2,2′-azobis[2-methyl-N-(2-hydroxyethyl)propionamide], and 4,4′-azobis(4□cyanovalerate)). They may be used alone or in combination with one another. Exemplary among them are persulfate, for example, potassium persulfate, ammonium persulfate, and sodium persulfate, from the standpoint of availability and easy handling.

Any one of the foregoing polymerization initiators may be used in combination with a reducing agent such as sodium sulfite, sodium hydrogen sulfite, ferrous sulfate, L-ascorbic acid, and N,N,N′,N′-tetramethylethylenediamine, so that it functions as a redox polymerization initiator.

The polymerization initiator can be used in an amount of 2 to 6 pbw, for example, 3 to 5 pbw, for 100 pbw of the total amount of the monomers. This amount can be desirable for the polymerization reaction to proceed completely to give a polymer having an adequate molecular weight, without causing viscosity increase and coagulation.

As appropriate, the foregoing (co)polymerization may be carried out in the presence of a chain transfer agent exemplified below. Thiols (such as n-laurylmercaptan, mercaptoethanol, and triethyleneglycol dimercaptan), thiolic acids (such as thioglycolic acid and thiomalic acid), secondary alcohols (such as isopropanol), amines (such as dibutylamine), and hypophosphite (such as sodium hypophosphite).

The (co)polymerization mentioned above may be carried out under any conditions without specific restrictions. For example, the temperature for (co)polymerization may be appropriately established according to the type and amount of the monomer and polymerization initiator. It may range from 35 to 75° C., for example, from 40 to 50° C. This temperature can be desirable for the polymerization reaction to proceed completely without volatilizing the disperse medium, which allows the monomer component to be dispersed thoroughly. Duration of the polymerization can be longer than 0.5 hours, for example, 1 to 5 hours.

The polymerization may be carried out under any pressure without specific restrictions, such as atmospheric pressure, reduced pressure, and positive pressure. The polymerization may also be carried out under any atmosphere, including air and inert gas (such as helium, nitrogen, and argon).

The above-mentioned crosslinking agent (iii), which has two or more reactive functional groups other than the polymerizable unsaturated groups, may be added at any time without specific restrictions after the completion of the polymerization of the monomers.

No specific restrictions are imposed on the conditions of the post-crosslinking reaction to be carried out after the (co)polymerization and crosslinking reaction. The conditions depend on the type of the crosslinking agent to be used and cannot be determined uniquely, but in general, the reaction temperature ranges from 40 to 160° C., for example, from 50 to 150° C., and the reaction time ranges from 0.5 to 60 hours, for example, from 1 to 48 hours.

The (co)polymerization may be carried out in such a way that a pore-forming agent in an amount for supersaturation is added to the monomer solution. The water-swellable polymeric material obtained in this manner will be porous. The pore-forming agent can be one which is insoluble in the monomer solution but is soluble in the washing solution. Examples of the pore-forming agent include sodium chloride, potassium chloride, ice, sucrose, and sodium hydrogen carbonate, while the sodium chloride can be desirable. The concentration of the pore-forming agent can be 5 to 50 wt %, for example, 10 to 30 wt %, for the total amount of the monomer solution.

The water-swellable polymeric material thus obtained may optionally be heat-dried, crushed into a desired form such as fine particles. The resulting fine particles may subsequently undergo classification through a sieve of adequate opening. The fine particles of the water-swellable polymeric material can be controlled and varied in shape and in average particle diameter depending on the conditions under which the water-swellable polymeric material is produced, such as the type of the monomer, the temperature and duration of the copolymerization, and the type and amount of the dispersion stabilizer.

The water-swellable polymeric material swells under certain pH conditions. For example, it swells upon contact with water at pH 7 and above, for example, under weak-alkaline conditions at pH 7.3 to 7.6 such as in blood.

### Method for Production of Medical Device

An exemplary method for production of a medical device is next described. Although the method is not specifically restricted, in an exemplary embodiment, the reactive functional groups of the water-swellable polymeric material is chemically bonded with those ions existing on the surface of the electrically conductive material through electrochemical reaction. The medical device is produced in the following way. First, a solution is prepared from the previously crosslinked water-swellable polymeric material which can have a plurality (for example, three or more) of reactive functional groups. Next, the electrically conductive material is immersed in the solution with an electrode. A voltage is applied across the electrically conductive material and the electrode, one of which functions as an anode with the other functioning as a cathode. The voltage application brings about electrochemical reactions between the reactive functional groups and those ions existing on the surface of the electrically conductive material.

An exemplary embodiment of the method for producing the medical device will be explained below with reference to FIG. 2. This method is intended to achieve the chemical bonding through electrochemical reactions between the reactive functional groups of the water-swellable polymeric material and those ions existing on the surface of the electrically conductive material. In this exemplary embodiment, the reactive functional groups of the water-swellable polymeric material are hydroxyl groups. The following description is not intended to restrict the method for producing the medical device; instead, any suitable method can be employed as well.

In the case where the water-swellable polymeric material has carboxyl groups as the reactive functional groups, the carboxyl groups release protons in an aqueous solution, thereby dissociating into carboxyl ions (—COO⁻) and hydrogen ions (H+). With the voltage being applied to the anode and cathode, the carboxyl ions (—COO⁻) migrate to the anode (which is the electrically conductive material) in the aqueous solution. Thus the carboxyl ions adsorb to the anode to give electrons to it. Since the reactive functional groups of the water-swellable polymeric material have lone-pair electrons to be shared with free electrons of the anode (electrically conductive material), there occur strong chemical bonds between the reactive functional groups of the water-swellable polymeric material and the electrically conductive material functioning as the anode. These chemical bonds remain even after the electrification is stopped.

FIG. 2 illustrates the electrochemical reaction involved in an exemplary embodiment of the method for producing a medical device. Through the electrochemical reaction, the water-swellable polymeric material having reactive functional groups firmly adheres (bonds) to the surface of the electrically conductive material (such as metal). This electrical reaction occurs when the electrochemical potential in the electrochemical system changes due to external factors. It involves such steps as the migration of substances to the electrode, the adsorption of substances to the electrode, the dissociation of substances on the electrode, and the exchange of electrons on the electrode. The electrochemical reacting apparatus 10 shown in FIG. 2 has the electrolytic bath 11 which holds the water-swellable polymeric material 14 and the aqueous solution 15. Both the anode 12, which is an electrically conductive material, and the cathode 13, are immersed in the aqueous solution 15 of the electrolytic bath 11. Here, the water-swellable polymeric material is not specifically restricted in concentration so long as it exists in an amount sufficient for effective bonding (adhesion) to the electrically conductive material. For example, the concentration of the water-swellable polymeric material can be 1 to 30 wt %, for example, 5 to 15 wt %. This concentration is sufficient for the water-swellable polymeric material to firmly bond (adhere) to the electrically conductive material and a coating film having an exemplary thickness and density over the electrically conductive material can be formed. Thus the resulting medical device exhibits good lubricity and drug retaining ability and functions as the scaffold for cells. In addition, the formed coating film can possess good lubricity. For example, the thus formed coating film also does not catch blood cells even when the medical device coated therewith is indwelled in blood.

The aqueous solution 15 may be water alone, but it can be one which contains an inorganic electrolyte dissolved therein. The inorganic electrolyte is not specifically restricted. It includes sodium chloride, potassium chloride, potassium dihydrogen phosphate (KH₂PO₄), dipotassium hydrogen phosphate (K₂HPO₄), disodium hydrogen phosphate (Na₂HPO₄), sodium dihydrogen phosphate (NaH₂PO₄), sodium phosphate (Na₃PO₄), and potassium phosphate (K₃PO₄). Exemplary among them are sodium chloride and potassium chloride. The aqueous solution containing such inorganic electrolyte exhibits electric conductivity, thereby facilitating the migration of electrons across the anode and cathode. The concentration of the inorganic electrolyte is not specifically restricted so long as it is high enough for electrons to migrate easily across the anode and cathode in the aqueous solution. For example, the concentration of the inorganic electrolyte can be 1 to 5 wt %, for example, 1.3 to 4 wt %. With the concentration in this range, the aqueous solution can have a sufficient electric conductivity while preventing ions of the inorganic electrolyte from being adsorbed to the metal surface.

The coating film to be formed from the water-swellable polymeric material can have a thickness of 0.1 to 20 μm, for example, 1 to 20 μm. The thickness in this range can be desirable for the medical device to exhibit good lubricity and for the coating film thereon not to catch blood cells. It can also be desirable for the medical device to exhibit good lubricity and drug retaining ability and function as the scaffold for cells. Further, the coating film would be smooth surface and uniform in thickness. In the case where the medical device is a stent, the coating film with smooth surface and uniform thickness permits endothelial cells to grow thereon at a substantially equal rate. It can prevent the adhesion to blood platelets from occurring. Incidentally, the coating film having such thickness can be formed easily as above by allowing a monomolecular layer of the water-swellable polymeric material to bond (adhere) onto an electrically conductive material. In addition, owing to the direct contact between the water-swellable polymeric material and the electrically conductive material, there exists a very strong bond between the electrically conductive material and the coating film of the water-swellable polymeric material. This strong bond can substantially or completely prevent the coating film from peeling off and falling from the substrate.

The conditions for electrochemical reaction are not specifically restricted. The electrochemical reaction takes place between those ions existing on the surface of the electrically conductive material and the reactive functional groups of the water-swellable polymeric material, thereby allowing the water-swellable polymeric material to bond (adhere) onto the electrically conductive material. For example, the voltage across the anode and cathode can be 0.1 to 10 V, for example, 2 to 7 V, although it is not specifically restricted. The voltage in this range is enough for the water-swellable polymeric material to form a uniform film firmly bonding to the surface of the electrically conductive material (anode or cathode). The duration of the voltage application is not specifically restricted; it can be 1 to 120 seconds, for example, 2 to 10 seconds. According to the production method, voltage application for a very short period of time as mentioned above brings about the electrochemical reaction between those ions existing on the surface of the electrically conductive material and the reactive functional groups of the water-swellable polymeric material, thereby allowing the water-swellable polymeric material to bond (adhere) onto the electrically conductive material. In addition, the reaction temperature is not specifically restricted; it can be 10 to 40° C., for example, 15 to 30° C.

As mentioned above, according to an exemplary production method, the electrochemical reaction may be carried out in an aqueous solution at a normal temperature. This can be advantageous because the method can as well be applied to any medical device including parts that are other than metal and poor in heat or solvent resistance. In addition, for example, it forms the coating film of the water-swellable polymeric material only on the surface of the electrically conductive material without the possibility of forming unnecessary coating on other parts.

As mentioned above, the method includes immersing the electrically conductive material in a solution of the water-swellable polymeric material and allowing the water-swellable polymeric material to bond (adhere) to the surface of the electrically conductive material through electrochemical reaction. In the course of this electrochemical reaction, there may occur uneven coating of the water-swellable polymeric material (due to partial variation in adhesion), for example, in the early stage of the reaction. Even in such a case, the foregoing method eventually forms a smooth uniform film of the water-swellable polymeric material on the surface of the electrically conductive material because the current density varies in inverse proportion to the amount of the water-swellable polymeric material adhering to the surface of the electrically conductive material. The water-swellable polymeric material therefore deposits selectively on the parts where the amount of adhering water-swellable polymeric material is less. Further, even when the electrically conductive material (substrate) is not completely covered with the coating film and is partly left exposed or uncovered, the exposed part is the electrically conductive material (substrate) and hence there is no need to consider the effect of the constituent of an intermediate layer.

Description has been made above with reference to FIG. 2 of the case in which the reactive functional groups of the water-swellable polymeric material are carboxyl groups (which become charged negatively in an aqueous solution). The same can apply to any other reactive functional groups which become charged negatively in an aqueous solution. On the other hand, in the case where the reactive functional groups of the water-swellable polymeric material become charged positively in an aqueous solution, for example, in case where the reactive functional groups are amino groups, they turn into quaternary ammonium groups by addition of protons and migrate to the cathode (instead of anode), so that the quaternary ammonium groups dissociate into amino groups and protons on the cathode upon adsorption onto the cathode. Electrons are given toward the protons from the cathode, and this reaction gives rise to hydrogen gas. The amino groups have lone-pair electrons which are shared with free electrons of the electrically conductive material (such as metal) as the cathode. This leads to a strong linkage between the reactive functional groups and the electrically conductive material as the cathode, and this linkage remains even after the electrification is stopped.

The medical device may contain a physiologically active substance in addition to the electrically conductive material and the water-swellable polymeric material. The physiologically active substance may be introduced in any way without specific restrictions; any suitable method is acceptable which is applied to medical devices. An exemplary way is by application of a solution or dispersion of a physiologically active substance onto the coating film of the water-swellable polymeric material. The physiologically active substance is not specifically restricted; its selection depends on the type of the medical device. Examples are listed below. Streptokinase, plasminogen activator, urokinase, etc., which promote dissolution or metabolism of thrombi or thrombus complexes. Acetylsalicylic acid, ticlopidine, dipyridamole, etc., as antiplatelet drugs; and GP IIb/IIIa antagonist, heparin, warfarin potassium, etc., as anticoagulants, which prevent the increase of thrombi or thrombus complexes. Anticancer drugs, immunosuppressive drugs, antibiotics, antirheumatic drugs, antithrombotic drugs, HMG-CoA reductase inhibitors, ACE inhibitors, calcium antagonist, hypolipidemic drugs, anti-inflammatory drugs, interferons, etc., which suppress intimal thickening or promote endothelialization or promote stabilize unstable plaque. These physiologically active substances may be used alone or in combination with one another.

The medical device and the medical device produced by the method can be inserted into any part of a mammal, for example, in a living human body. It can be inserted into the body cavity, such as blood vessel, cardiac cavity, esophagus, gastral cavity, and intestine, which can require medical devices with surface lubricity. The medical device may take on any shape suitable for insertion into the living body; it can find use as a stent, embolic coil, artificial heart valve, pacemaker, artificial blood vessel, etc., which are indwelled in the living body for a long period of time, as well as guide wire, catheter, thrombus removing filter, etc., which are indwelled in the living body for a short period of time.

### EXAMPLES

Exemplary aspects will be described in more detail with reference to the following examples and comparative examples, which are not intended to restrict the technical scope thereof.

### Production Example 1

### Preparation of Water-Swellable Polymeric Material

In a 300-mL beaker were placed liquid paraffin (150 g) and sorbitan sesquioleate (19.0 g). The reactants were stirred by a magnetic stirrer to prepare a continuous phase for reverse phase suspension polymerization. The resulting continuous phase was freed of dissolved oxygen by allowing nitrogen gas to flow through it for 30 minutes. In addition to the continuous phase, there was prepared an aqueous solution of monomer from acrylamide (3.8 g), sodium acrylate (2.2 g), N,N′-methylenebisacrylamide (0.013 g), and sodium chloride (5.4 g) dissolved in distilled water (19.9 g) which were stirred by a magnetic stirrer in a 50-mL brown glass bottle. The aqueous solution of monomer prepared as mentioned above was given ammonium persulfate (0.27 g) dissolved in distilled water (2.0 g), and the resulting solution was entirely added to the continuous phase prepared as mentioned above. The resulting mixture was stirred at 500 rpm so as to disperse the monomer solution into the continuous phase. After stirring for 30 minutes and heating up to 40° C., the mixture was incorporated with N,N,N′,N′-tetramethylethylenediamine (500 μL). After continued stirring for 1 hour, the contents in the beaker were transferred into a 3-L beaker. The beaker was given dimethylsulfoxide (1 L), followed by stirring for 5 minutes. The resulting product was suction filtered through filter paper. A powdery product was then obtained on the filter paper. The powdery product was washed sequentially with hexane (1000 mL) and ethanol (1000 mL), followed by drying under reduced pressure. Thus there was obtained the water-swellable polymeric material in the form of powder (or hydrogel fine particles). The yield was 5.8 g. The thus obtained water-swellable polymeric material was dispersed in ethanol and its average pardicle diameter was measured using a Coulter counter (LS-230, made by Beckman-Coulter Inc.). The average particle diameter of the material was 5 μm.

### Example 1

In RO water (filtered through a reverse osmosis membrane) were dissolved 9 wt % of the water-swellable polymeric material having an average particle diameter of 5 μm (prepared in Production Example 1 mentioned above) and 2.25 wt % of sodium chloride. The resulting aqueous (8 g) solution was thoroughly stirred with a stirrer to give a gel-like solution (referred to as solution A).

In the gel-like solution A was immersed a stainless steel stent (Tsunami® 3015, made by Terumo Corp.) having a diameter of 0.95 mm, which serves as the anode and electrically conductive material. In the gel-like solution A was also immersed a stainless steel needle having a diameter of 0.7 mm, which serves as the cathode, in such a way that the stent and the needle are arranged coaxially. The two electrodes were energized for 2 seconds by connection to a DC source of 4.5 volts generated from serially connected three dry cells (size AA). The voltage application caused the water-swellable polymeric material to ionize, so that the resulting carboxylate (—COO⁻) adhered to (or deposited on) the anode (or the stent) through electrochemical reaction. The treated stent was washed with water and then dried in an oven at 60° C. for more than 1 hour. Thus there was obtained a stent which has a coating film (5 μm thick) of water-swellable polymeric material. The coating film of the water-swellable polymeric material (fine particles), which adheres to the stent, was hydrated, swollen and colored by dipping in a PBS solution of methyleneblue (0.1 wt %) for dyeing. It was found that the stent was coated with a uniform thin film on both surfaces thereof. It was also found that the coating film remained firmly bonding to the stent without peeling off when the coated stent was rubbed in water.

### Example 2

In a cylindrical glass container, measuring 5 mm in inside diameter and 5 cm in height, was placed an aqueous solution (3.5 mL) containing 6 wt % of the water-swellable polymeric material having an average particle diameter of 5 μm (prepared in Production Example 1 mentioned above) and 1.5 wt % of sodium chloride. Then, in the solution were immersed two electrodes 5 cm deep, each being a Ni—Ti wire measuring 0.3 mm in diameter and 6 cm in length, as the two electrodes separate from each other. The two electrodes were energized with 4.5 volts for 2 seconds at 25° C., so that the water-swellable polymeric material is ionized and the thus resulting carboxylate (—COO⁻) groups bond (adhere) to the surface of the Ni—Ti wire (as the anode) through electrochemical reaction. Subsequently, the Ni—Ti wire was washed with water and dried in an oven at 60° C. for more than 5 minutes. Thus there was obtained the Ni—Ti wire having a coating film (5 μm thick) of the water-swellable polymeric material formed thereon (or fixed thereto).

### Example 3

Electrolysis was accomplished by using a discoid plate of SUS316L (15 mm in diameter) as the anode and a metal wire of SUS316L (0.7 mm in diameter) as the cathode. The discoid plate was immersed in an aqueous solution containing 6 wt % of the water-swellable polymeric material having an average particle diameter of 5 μm (prepared in Production Example 1 mentioned above) and 1.5 wt % of sodium chloride. The metal wire was also immersed in the aqueous solution such that its axis coincides with the axis of the discoid plate. The electrodes were energized with 4.5 volts for 2 seconds at 25° C., so that the water-swellable polymeric material is ionized and the thus resulting carboxylate (—COO⁻) groups bond (adhere) to the surface of the discoid plate (as the anode) through electrochemical reaction. Subsequently, the discoid plate was washed with water and dried in an oven at 60° C. for more than 5 minutes. Thus there was obtained a discoid plate having a coating film (5 μm thick) of the water-swellable polymeric material formed thereon (or fixed thereto).

### Comparative Example 1

The same test as disclosed in Example 1 of U.S. Application Publication No. 2009/0124984 A1 was repeated in the following way. A cylindrical glass container measuring 5 mm in inside diameter and 5 cm in height was filled with an aqueous solution (3.5 mL) containing 12 wt % of polyethylene glycol diamine (PEG diamine: H₂NCH₂CH₂CH₂—(OCH₂CH₂)ₙ—O—CH₂CH₂CH₂NH₂, MW=10,000, SUNBRIGHT® DE-100PA, made by Nichiyu Co., Ltd.) and 3 wt % of sodium chloride. In the aqueous solution were immersed two Ni—Ti wires, each measuring 0.3 mm in diameter and 6 cm in length, as the anode and cathode separate from each other and 5 cm deep. The two electrodes were energized with 4.5 volts at 25° C. for 3 minutes so as to ionize the PEG diamine. Ionization causes protons to attach to the terminal amino groups (ammonium groups) and deposit on the surface of the cathode. Upon deposition on the surface of the cathode, the protons are reduced to hydrogen and the amino groups form covalent bonds with free electrons, thereby causing the PEG diamine to bond to (or deposit on) the surface of the Ni—Ti wire. Finally, the coated Ni—Ti wire was dried in an oven at 60° C. for more than 5 minutes.

### Comparative Example 2

The same Ni—Ti wires (0.3 mm in diameter and 6 cm in length) as used in Example 2 and Comparative Example 1 were used, except that they have no coating.

### Comparative Example 3

Electrolysis was accomplished by using a discoid plate of SUS316L (15 mm in diameter) as the anode and a metal wire of SUS316L (0.7 mm in diameter) as the cathode. The discoid plate was immersed in an aqueous solution containing 12 wt % of polyethylene glycol diamine (PEG diamine) (SUNBRIGHT® DE-100PA, made by Nichiyu Co., Ltd.) and 3 wt % of sodium chloride. The metal wire as the anode was also immersed in the aqueous solution such that its axis coincides with the axis of the discoid plate. The electrodes were energized with 4.5 volts for 3 minutes at 25° C., so that the terminal amino groups (cations) of the PEG diamine fix to (or deposit on) the surface of the discoid plate (as the cathode) through electrochemical reaction. Finally, the discoid plate was washed with water and dried in an oven at 60° C. for more than 5 minutes.

### Evaluation 1:

### Durability Test for Lubricity (Ni—Ti Wire)

The coated Ni—Ti wires prepared in Example 2 and Comparative Examples 1 and 2 were tested to evaluate the lubricity and its durability of each coating film in the following way. Each test piece (2 cm long) was placed on a silicone rubber sheet, which was subsequently immersed horizontally in water. The rubber sheet was inclined until the test piece slips down, and the angle of the inclination (θ) was measured. The value of tan(θ) of the angle is regarded as the coefficient of static friction, which is used as an indication of lubricity. The foregoing procedure was repeated 10 times to evaluate the durability of lubricity. The smaller the coefficient of static friction is, the better the lubricity is. The results of the test are shown in Table 1 below.

TABLE 1

| | Coefficient of static friction | | |
|---|---|---|---|
| Number of test | | Comparative | Comparative |
| procedure | Example 2 | Example 1 | Example 2 |
| 1 time | 0.23 | 0.29 | 0.48 |
| 5 times | 0.23 | 0.41 | 0.48 |
| 10 times | 0.23 | 0.48 | 0.48 |

It is noted from Table 1 that the wire in Example 2 exhibits a tan(θ) of 0.23 and keeps this value even when the procedure of inclination is repeated 10 times. By contrast, the wire in Comparative Example 1 exhibits a tan(θ) of 0.29 initially, however, the tan(θ) is equal to that of the uncoated wire in Comparative Example 2 when the procedure of inclination is repeated 5 or more times. This suggests that the coating film peels off as it repeatedly experiences the procedure of inclination in water. It is concluded from the foregoing result that the wire in Example 2 is superior in lubricity to the uncoated wire in Comparative Example 2 and is also superior in the durability of lubricity to the wire coated with PEG diamine in Comparative Example 1.

### Evaluation 2:

### Durability Test for Wettability (SUS Discoid Plate)

The coated discoid plates prepared in Example 3 and Comparative Example 3 were tested to evaluate the adhesion of the coating film by measuring the change in wettability in the following way. Each discoid plate was entirely wetted with RO water and then subjected to shearing under a load of 0.01 N with Kimwipes™ available from Kimberly-Clark Corp. This procedure was repeated 10 times. A droplet of RO water (10 μL) was placed on the discoid plate, and the angle of contact of the droplet was measured. Incidentally, the discoid plates in Example 3 and Comparative Example 3 were also examined for the angle of contact immediately after electrodeposition.

For the purpose of comparison with samples in dry state, the discoid plates in Example 3 and Comparative Example 3 were rubbed ten times with Kimwipes™ available from Kimberly-Clark Corp under a pressure of about 30 N by fingers. Then, a droplet of RO water (10 μL) was placed on the discoid plate, and the angle of contact of the droplet was measured.

The results of the test are shown in Table 2 below.

TABLE 2

| | Example 3 | Comparative Example 3 |
|---|---|---|
| Wettability of surface | No larger than 20° | No larger than 20° |
| after electrodeposition | | |
| Wettability after | No larger than 20° | 50° |
| shearing under load | | |
| (0.01N) in wet state | | |
| Wettability after | No larger than 20° | 55° |
| shearing under load | | |
| (30N) in dry state | | |
| Conclusion | Wettability remains | Wettability decreases |
| | after shearing. Coating | after shearing. Coating |
| | layer remains stable. | layer peels off. |

It is noted from Table 2 that the discoid plate in Example 3 changes little in wettability while the discoid plate in Comparative Example 3 changes significantly in wettability when they undergo shearing under a load (0.01 N) in a wet state.

It is noted from Table 2 that the discoid plate in Example 3 changes little in wettability while the discoid plate in Comparative Example 3 changes significantly in wettability when they undergo shearing under a load (30 N) in a dry state.

Principles, preferred embodiments disclosed by way of example and other disclosed aspects of the medical device and production method have been described in the foregoing specification. However, the invention intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A medical device, comprising an electrically conductive material and a water-swellable polymeric material having reactive functional groups and being previously crosslinked, the reactive functional groups of the water-swellable polymeric material being chemically bonded with ions existing on the surface of the electrically conductive material.

2. The medical device according to claim 1, wherein the water-swellable polymeric material is in a form of fine particles.

3. The medical device according to claim 1, wherein the reactive functional group includes at least one selected from the group consisting of a carboxyl group, amino group, imino group, amide group, imide group, epoxy group, isocyanate group, cyano group, nitro group, mercapto group, and phosphino group.

4. The medical device according to claim 1, wherein the water-swellable polymeric material includes a water-swellable crosslinked polymer, the water-swellable crosslinked polymer being obtained by crosslinking of a copolymer containing constituent units formed from (meth) acrylamide monomer and constituent units formed from unsaturated carboxylic acid by a crosslinking agent.

5. The medical device according to claim 1, wherein the ions and the reactive functional groups are chemically bonded together through an electrochemical reaction.

6. The medical device according to claim 1, wherein the electrically conductive material is a metal.

7. The medical device according to claim 1, wherein the water-swellable polymeric material has a plurality of reactive functional groups.

8. A method for producing a medical device, said method comprising:
immersing an electrically conductive material and an electrode in a solution of a water-swellable polymeric material having reactive functional groups and being previously crosslinked; and
applying a voltage across the electrically conductive material and the electrode with one of the two functioning as an anode and the other as a cathode, to bring about chemical reaction between ions existing on the surface of the electrically conductive material and the reactive functional groups.

9. The method for producing a medical device according to claim 8, wherein the chemical reaction is accomplished by application of voltage ranging from 0.1 to 10 V for 1 to 120 seconds.

10. The medical device according to claim 2, wherein the reactive functional group includes at least one selected from the group consisting of a carboxyl group, amino group, imino group, amide group, imide group, epoxy group, isocyanate group, cyano group, nitro group, mercapto group, and phosphino group.

11. The medical device according to claim 2, wherein the water-swellable polymeric material includes a water-swellable crosslinked polymer, the water-swellable crosslinked polymer being obtained by crosslinking of a copolymer containing constituent units formed from (meth) acrylamide monomer and constituent units formed from unsaturated carboxylic acid by a crosslinking agent.

12. The medical device according to claim 3, wherein the water-swellable polymeric material includes a water-swellable crosslinked polymer, the water-swellable crosslinked polymer being obtained by crosslinking of a copolymer containing constituent units formed from (meth) acrylamide monomer and constituent units formed from unsaturated carboxylic acid by a crosslinking agent.

13. The medical device according to claim 2, wherein the ions and the reactive functional groups are chemically bonded together through an electrochemical reaction.

14. The medical device according to claim 3, wherein the ions and the reactive functional groups are chemically bonded together through an electrochemical reaction.

15. The medical device according to claim 4, wherein the ions and the reactive functional groups are chemically bonded together through an electrochemical reaction.

16. The medical device according to claim 2, wherein the electrically conductive material is a metal.

17. The medical device according to claim 3, wherein the electrically conductive material is a metal.

18. The medical device according to claim 4, wherein the electrically conductive material is a metal.

19. The medical device according to claim 2, wherein the water-swellable polymeric material has a plurality of reactive functional groups.

20. The medical device according to claim 3, wherein the water-swellable polymeric material has a plurality of reactive functional groups.
